(19) United States
(12) Patent Application Publication
(10) Pub. No.: US 2026/0304545 A1
(43) Pub. Date: Oct. 1, 2026

(54) MANAGING RADIO ACCESS IN UE HAVING FIRST RADIO AND SECOND RADIO

(71) Applicant: Samsung Electronics Co., Ltd., Suwon-si (KR)

(72) Inventors: Shouvik GUHA, Bangalore (IN); Neha SHARMA, Bangalore (IN)

(21) Appl. No.: 19/646,011

(22) Filed: Apr. 13, 2026

Related U.S. Application Data
(63) Continuation of application No. PCT/KR2026/095346, filed on Mar. 31, 2026.

(30) Foreign Application Priority Data
Apr. 1, 2025 (IN) 202541032448
Mar. 12, 2026 (IN) 2025 41032448

(51) Int. Cl. H04W 76/27; H04W 24/10; H04W 52/02; H04W 74/0833

(52) U.S. Cl. CPC H04W 76/27; H04W 24/10; H04W 52/0235; H04W 74/0833

(57) ABSTRACT

A method for managing a radio access in a user equipment (UE) having a first radio and a second radio are provided. The method includes initiating, by the UE, an operation in a low-power radio resource control connected state for enabling at least one of uplink communication or downlink communication using an optimized radio resource by the second radio f the UE, and transitioning, by the UE, the second radio into a low-power radio resource control (RRC) idle state during at least one of upon completion of a data transmission or triggering of a power saving condition.

### CROSS REFERENCE TO RELATED APPLICATION(S)

This application is a continuation application, claiming priority under 35 U.S.C. § 365(c), of an International application No. PCT/KR 2026/095346, filed on Mar. 31, 2026, which is based on and claims the benefit of an Indian Provisional patent application number 202541032448, filed on Apr. 1, 2025, in the Indian Intellectual Property Office, and of an Indian Complete patent application number 202541032448, filed on Mar. 12, 2026, in the Indian Intellectual Property Office, the disclosure of each of which is incorporated by reference herein in its entirety.

### BACKGROUND

### 1. Field

The disclosure relates to a wireless network. More particularly, the disclosure relates to managing an interworking of a low power radio (LR) and a main radio (MR) in the wireless network.

### 2. Description of Related Art

In the next generation of wireless communication systems, sustainability has become a critical theme. With the increasing demand for wireless connectivity, it is essential to design systems that align with sustainable development goals. The sixth generation (6G) of wireless communication systems is expected to play a significant role in achieving these goals by providing ultra-reliable, low-latency, and high-throughput connectivity while minimizing energy consumption and environmental impact.

In fifth generation (5G) networks, higher-layer protocols are optimized for a single radio link, which offers high throughput but consumes significant energy. This approach may not be very optimal for operations or services that require very little data or are only needed for control plane purposes. The radio is a vital element of wireless devices, such as smartphones, wearables, and Internet of things (IoT) devices. It facilitates wireless connectivity, which is crucial for enabling rich applications and ensuring a satisfactory standby time. However, high-performance radios that provide faster data rates tend to consume more power. Conversely, traditional methods that reduce radio power consumption often compromise performance. This creates a fundamental trade-off between performance and power savings in a single powerful radio design.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a dual-radio architecture for future generations of wireless communication systems (or wireless network).

Another aspect of the disclosure is to provide mechanisms and signaling protocols to handle the switching between a main power radio (MR) and a low-power radio (LR), which aims at reducing overall power consumption while maintaining satisfactory levels of performance, making it an ideal candidate for achieving sustainability goals in 6G systems.

Another aspect of the disclosure is to provide a radio resource control (RRC) state for LR operation. This would allow a network entity (e.g., base station or the like) and a user equipment (UE) to operate in harmony while operating with an LR mode.

Another aspect of the disclosure is to provide a network based method for the UE to perform switch from the low power radio (LR) to the main radio (MR).

Another aspect of the disclosure is to provide a UE based method for the UE to perform switch from the low power radio (LR) to the main radio (MR).

Another aspect of the disclosure is to handle failure during switch from the low power radio (LR) to the main radio (MR) at the UE and the network entity.

Another aspect of the disclosure is to allow the UE to send small data over the LR without needing to move to the MR.

Another aspect of the disclosure is to allow the UE to perform measurement of LR radio and report it to network entity.

Another aspect of the disclosure is to provide a method for the UE to report low power radio measurement to be sent to the network entity.

Additional aspects will be set forth in part in the description which follows and, in part, will be apparent from the description, or may be learned by practice of the presented embodiments.

In accordance with an aspect of the disclosure, a method for managing a radio access in a user equipment (UE) having a first radio and a second radio is provided. The method includes initiating, by the UE, an operation in a low-power radio resource control connected state for enabling at least one of uplink communication and downlink communication using an optimized radio resource by the second radio of the UE, and transitioning, by the UE, the second radio into a low-power radio resource control (RRC) idle state during at least one of upon completion of a data transmission and triggering of a power saving condition.

In an embodiment of the disclosure, the first radio is a main radio (MR) and the second radio is a low power radio (LR).

In accordance with another aspect of the disclosure, a method for managing a radio access in a UE having a first radio and a second radio is provided. The method includes monitoring, by a network entity, a power consumption of the network entity by using a data driven model, and transitioning, by the UE, the second radio from a first radio based on the power consumption at the UE.

In accordance with another aspect of the disclosure, a UE including a first radio and a second radio is provided. The UE includes memory including one or more storage media, storing instructions, a radio access managing controller, and at least one processor communicatively coupled to the memory and the radio access managing controller, wherein the instructions, when executed by the at least one processor individually or collectively, cause the UE to initiate an operation in a low-power radio resource control connected state for enabling at least one of uplink communication and downlink communication using an optimized radio resource by the second radio of the UE, and transition the second radio into a low-power RRC idle state during at least one of upon completion of a data transmission and triggering of a power saving condition.

In accordance with another aspect of the disclosure, a network entity for managing a radio access in a UE having a first radio and a second radio is provided. The network entity includes memory including one or more storage media, storing instructions, a radio access managing controller, and at least one processor communicatively coupled to the memory and the radio access managing controller, wherein the instructions, when executed by the at least one processor individually or collectively, cause the network entity to monitor a power consumption of the network entity by using a data driven model, and transition the second radio from a first radio based on the power consumption at the UE.

In accordance with another aspect of the disclosure, one or more non-transitory computer-readable storage media storing one or more computer programs including computer-executable instructions that, when executed by one or more processors of a radio access in a user equipment (UE) having a first radio and a second radio individually or collectively, cause the UE to perform operations are provided. The operations include initiating, by the UE, an operation in a low-power radio resource control connected state for enabling at least one of uplink communication or downlink communication using an optimized radio resource by the second radio of the UE, and transitioning, by the UE, the second radio into a low-power radio resource control (RRC) idle state during at least one of upon completion of a data transmission or triggering of a power saving condition.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a user equipment (UE) according to an embodiment of the disclosure;

FIG. 2 is a block diagram illustrating a network entity according to an embodiment of the disclosure;

FIG. 3 is a flow chart illustrating a method, implemented by a UE, for managing a radio access in the UE having a first radio and a second radio according to an embodiment of the disclosure;

FIG. 4 is a flow chart illustrating a method, implemented by a network entity, for managing a radio access in a UE having a first radio and a second radio, according to an embodiment of the disclosure;

FIG. 5 illustrates a low power radio (LR) radio resource control (RRC) state machine, and example events for state transitions from a LR to a main radio (MR) respectively according to an embodiment of the disclosure;

FIGS. 6 and 7 are sequence diagrams depicting a process of a network entity directed LR to MR success scenarios according to various embodiments of the disclosure;

FIGS. 8 and 9 are sequence diagrams depicting a process of network entity directed LR to MR failure scenarios according to various embodiments of the disclosure;

FIG. 10 illustrates a scenario in which LR to MR switch directed by a UE according to an embodiment of the disclosure; and

FIG. 11 is a sequence diagram illustrating a method to perform measurement in a UE (i.e., dual radio devices) according to an embodiment of the disclosure.

The same reference numerals are used to represent the same elements throughout the drawings.

### DETAILED DESCRIPTION

The following description with reference the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration. Any embodiment or implementation of the disclosure described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports, such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by symbols of the related art, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by symbols of the related art, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words, such as first, second, third, or the like, to describe components/elements/steps is for the purposes of this description and should not be construed as sequential ordering/placement/occurrence unless specified otherwise.

Hereinafter, embodiments of the disclosure will be described with reference to the accompanying drawings.

In describing the embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined based on the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded individually or collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “~unit/module” may refer to a software element or a hardware element, such as a field programmable gate array (FPGA) or an application specific integrated circuit (ASIC), which performs a predetermined function. However, the term including the word “~unit/module” does not always have a meaning limited to software or hardware. The “~unit/module” may be constructed either to be stored in an addressable storage medium or to execute one or more processors. Therefore, the “~unit/module” includes, for example, software elements, object-oriented software elements, components, such as class elements and task elements, processes, functions, properties, procedures, sub-routines, segments of a program code, drivers, firmware, micro-codes, circuits, data, database, data structures, tables, arrays, and parameters. The components and functions provided by the “~unit/module” may be either combined into a smaller number of components and a “~unit/module,” or divided into additional components and a “~unit/module.” Moreover, the components and “~units/module” may be implemented to reproduce one or more central processing units (CPUs) within a device or a security multimedia card. Further, in the embodiments of the disclosure, the “~unit/module” may include one or more processors.

The entirety of the one or more computer programs may be stored in a single memory device, or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, microprocessors, microcontrollers, digital signal processors, FPGA, ASIC, a microprocessor unit (MPU), a system on chip (SoC), an IC, or the like. The one processor or the combination of processors executes instructions that can be stored in memory, such as the operating system, in order to control the overall operation of the device. In addition, the one processor or the combination of processors is also capable of executing other processes and programs resident in the memory, such as processes for the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure. Additionally, or alternatively, such software may be a computer program [product] comprising instructions which, when executed by one or more processors of an electronic device individually or collectively, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the disclosure may provide a program comprising code for implementing apparatus or a method as claimed in any one of the claims of this specification and a non-transitory machine-readable storage storing such a program.

Hereinafter, the determination of priority between A and B in the disclosure may refer to various actions, such as selecting the one having a higher priority based on a predefined priority rule and performing an operation corresponding thereto, or omitting or dropping an operation corresponding to the one having a lower priority.

Hereinafter, “A or B” as described in the disclosure may be understood as “A and/or B,” which may include A, or B, or both A and B.

In addition, “at least one of A, B, and C” as described in the disclosure may be understood to include A, or B, or C, or any combination of A, B, and C.

In addition, “at least one of A, B, or C” as described in the disclosure may be understood to include A, or B, or C, or any combination of A, B, and C.

Furthermore, “A/B” as described in the disclosure may be understood as “A and/or B,” which may include A, or B, or both A and B.

Furthermore, “A, B” as described in the disclosure may be understood as “A and/or B,” which may include A, or B, or both A and B.

Furthermore, “A and B” as described in the disclosure may be understood as “A and/or B,” which may include A, or B, or both A and B.

Furthermore, “if condition A and condition B are satisfied,” as described in the disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms, such as “first,” “second,” “third,” or the like, (and similar qualifiers) are used merely to distinguish between different instances, occurrences, configurations, messages, stages, elements or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ~”, “second ~”, or the like, as described in the disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ~” and “second ~” are described in the disclosure, it may be understood that element(s) referred to by “first ~” and “second ~” may be the same or different. For example, in case of element(s) being information, first information and second information may both be the same information, and, in some cases, are separate and different information.

In addition, the terms “if ~” and “in case that ~” as used in the disclosure or claims may be interpreted to include the meanings of “when (or upon) ~,” “in response to ~,” “based on ~,” or “according to ~,” and may be used interchangeably with these expressions. In addition, expressions other than those exemplified herein may also be used, as long as they have substantially the same meaning and do not impair the technical features of the disclosure. If a method step (e.g., transmit a signal) is performed according to the disclosure of the application in connection with one of the above terms (such as “in case that ~” or the like), it may be interpreted to include the meanings (disclosure) of a prior determination that a feature has a specific state “~” (e.g., a bit length is above X), and then perform the method step in response to said determination.

In addition, the term “not perform” as used in the disclosure or claims may, in context, be understood to mean that the corresponding step is omitted or skipped. Such a term may be replaced with other terms having the same or substantially equivalent meaning.

In addition, “transmitting a message including A and B” as described in the disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the disclosure described below, terms or components included in embodiments of the disclosure may be expressed in singular or plural form depending on the specific embodiments presented. However, such singular or plural expressions are selected appropriately for convenience of description, and the disclosure is not limited to a singular or plural number of components. A component expressed in the plural form may be implemented as a single component, and a component expressed in the singular form may be implemented as multiple components.

The drawings or flowcharts described below illustrate example methods that may be implemented according to the principles of the disclosure, and various modifications may be made to the methods illustrated in the flowcharts of the disclosure. For example, although illustrated as a series of steps, various steps in each drawing or flowchart may overlap, occur in parallel, occur in a different order, or be repeated. In other examples, any step may be omitted or replaced with another step.

The process of the flowchart may be performed by a device. One or more of the steps of the flowchart can be implemented by one or more processors/computer programs executing instructions to perform the noted functions.

The methods and apparatuses proposed in the embodiments of the disclosure may be disclosed in connection with drawings disclosing flowcharts to illustrate example methods that may be implemented according to the principles of the disclosure. Such flowcharts may contain different branches and/or sub-branches. It is understood that the principles of the disclosure do not only contain the combination of all branches/sub-branches disclosed in the embodiment of the disclosure, but the disclosure also contains at least one isolated branch/isolated sub-branch, in particular to a single branch/single sub-branch.

The methods and apparatuses proposed in the embodiments of the disclosure are not limited to each embodiment individually, but may also be applied in combination of all or some of the embodiments proposed in the disclosure. Therefore, the embodiments of the disclosure may be modified and applied without significantly departing from the scope of the disclosure, as would be understood by those skilled in the art.

In this case, even if certain wordings are described differently across embodiments of the disclosure, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the disclosure is not limited to the terms described below, and other terms having equivalent technical meanings may also be used. Such terms may also be interchangeable with terms defined in any 3^{rd} generation partnership project (3GPP) technical specifications (TS) or similar technical specifications, e.g., from ETSI, where appropriate.

Hereinafter, a base station (BS) is an entity that allocates resources to terminals, and may be at least one of a gNode B, an eNode B, a Node B, a wireless access unit, a BS controller, or a node on a network.

Furthermore, the base station of the disclosure may include a split architecture comprising a central unit (CU) and a distributed unit (DU). In this structure, the CU is configured to process the higher layers of the control and user planes, while the DU is configured to process lower-layer radio resource functions. The embodiments of the disclosure may be equally applicable to 5G base station architectures in which such CU and DU functional splits are implemented.

A terminal may include a UE, a mobile station (MS), a cellular phone, a smartphone, a computer, a tablet, a wearable device, an Internet of things (IoT) device, or any other device/system capable of performing communication functions.

In embodiments of the disclosure, a downlink (DL) refers to a radio link through which a BS transmits a signal to a terminal, and an uplink (UL) refers to a radio link through which a terminal transmits a signal to a BS.

Furthermore, hereinafter, 5^{th} generation (5G) mobile communication technologies (e.g., 5G new radio (NR)), 6^{th} generation (6G) mobile communication technologies may be described by way of example, but the embodiments of the disclosure may also be applied to other communication systems having similar technical backgrounds or channel types. For example, newly evolved mobile communication systems developed after 5G and 6G may be included. Furthermore, based on determinations by those skilled in the art, the embodiments of the disclosure may also be applied to other communication systems (e.g., Wi-Fi systems) through some modifications without significantly departing from the scope of the disclosure

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. For example, in the disclosure, the expression “transmit a physical channel” may be interpreted as being equivalent to the expression “transmit data or a signal via a physical channel.”

Hereinafter, in the context of the disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as Layer 3 (L3) signaling.

In addition, Layer 1 (L1) signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

For example, the physical layer signaling (i.e., L1 signaling) may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as L3 signaling. It should be noted, however, that the higher layer signaling is not limited to the aforementioned examples.

Hereinafter, the expression that information is configured by the BS, as used in the disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the disclosure will be described with reference to the accompanying drawings.

The embodiments herein achieve a dual-radio architecture for future generations of wireless communication systems. In an embodiment of the disclosure, the method can be used for managing a radio access in a UE having a first radio and a second radio. The method includes initiating, by the UE, an operation in a low-power radio resource control connected state for enabling at least one of: uplink communication and downlink communication using an optimized radio resource by the second radio of the UE. Further, the method includes transitioning, by the UE, the second radio into a low-power radio resource control (RRC) idle state during at least one of: upon completion of a data transmission and triggering of a power saving condition.

Embodiments herein propose mechanisms and signaling protocols to handle the switching between the main power radio and the low-power radio. This approach aims at reducing overall power consumption while maintaining satisfactory levels of performance, making it an ideal candidate for achieving sustainability goals in 6G systems. By designing a dual-radio architecture that aligns with sustainability principles, the embodiments herein create a more energy-efficient and environmentally friendly wireless communication system. This approach not only reduces energy consumption but also optimizes the efficient use of resources, ultimately contributing to a more sustainable future.

Whenever the UE does not have any heavy user plane activity and wants to perform control plane maintenance like radio resource management (RRM) procedures or other protocol procedures, then, based on the proposed method, the UE can switch to LR for all operations and stay in LR-RRC state, with objective to save energy. Since, it is known that LR will be having lesser power consumption than MR, this will help reduce power consumption.

The proposed method could allow energy saving allowing the network entity (e.g., base station or the like) and the UE to remain in LR during less demanding operations and able to transition to MR when needed for high demanding operations. The proposed method aims to reduce overall power consumption while maintaining satisfactory levels of performance, making it an ideal candidate for achieving sustainability goals in 6G systems.

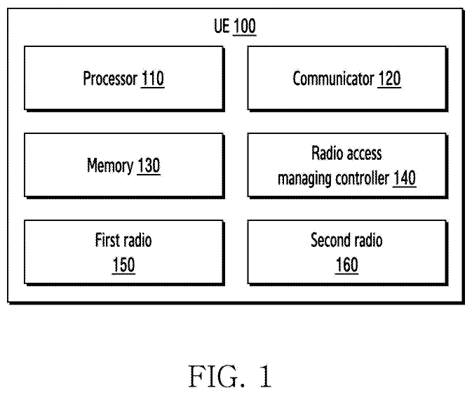

Referring now to the drawings, and more particularly to FIGS. 1 through 11, where similar reference characters denote corresponding features consistently throughout the figures, there are shown embodiments.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 is a block diagram illustrating a UE according to an embodiment of the disclosure.

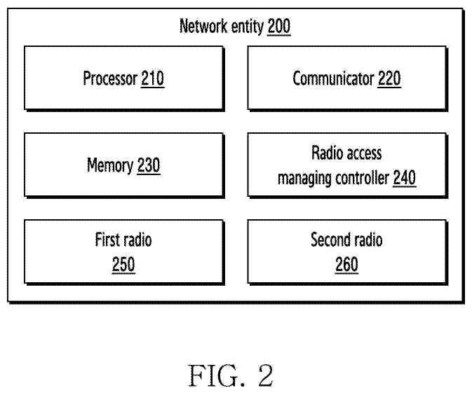

Referring to FIG. 1, in an embodiment of the disclosure, the UE 100 can be, for example, but not limited to a laptop, a desktop computer, a notebook, a device-to-device (D2D) device, a vehicle to everything (V2X) device, a smartphone, a foldable phone, a smart television (TV), a tablet, an immersive device, and an Internet of things (IoT) device. The UE 100 and a network entity 200 (as shown in FIG. 2) are included in a wireless network 300. The wireless network 300 can be, for example, but not limited to a NB-IoT network, a fifth generation (5G) network, an edge computing network, a sixth generation (6G) network, a long-term evolution (LTE) network, a long-term evolution-advanced (LTE-A) network or the like.

In an embodiment of the disclosure, the UE 100 includes a processor 110, a communicator 120, memory 130, a radio access managing controller 140, a first radio 150 and a second radio 160. The processor 110 is operated with the communicator 120, the memory 130, the radio access managing controller 140, the first radio 150 and the second radio 160. Further, the radio access managing controller 140 is physically implemented by analog or digital circuits, such as logic gates, integrated circuits, microprocessors, microcontrollers, memory circuits, passive electronic components, active electronic components, optical components, hardwired circuits, or the like, and may optionally be driven by firmware.

In an embodiment of the disclosure, the first radio 150 is a main radio (MR) or a primary radio, and the second radio 160 is a low power radio (LR). The primary radio responsible for handling demanding applications requiring high bandwidth and processing capabilities. The low-power radio (LR), tasked primarily with managing connections and performing ancillary functions, such as paging notifications, signal measurements, updating system parameters, and exchanging limited quantities of data packets.

This division allows each component to operate efficiently within their respective domains, thereby minimizing unnecessary expenditure of resources and leading to substantial reductions in total energy usage across the entire infrastructure.

To effectively implement the dual-radio architecture, various mechanisms must be put in place to perform switching between the two radios 150, 160. These mechanisms include defining triggering conditions for various procedures, such as when the primary radio should switch to the LR or vice versa, and establishing a signaling mechanism to facilitate seamless switching between the two radios 150, 160 (also called dual-radio architecture). Hence, the proposed method provides signaling protocols to handle the switching between the main power radio 150 and the low-power radio 160.

The radio access managing controller 140 initiates an operation in a low-power radio resource control connected state for enabling at least one of: uplink communication and downlink communication using an optimized radio resource by the second radio 160 of the UE 100. In an embodiment of the disclosure, the UE 100 initiates the data transmission in the low-power radio resource control connected state without activating the first radio 150.

In an embodiment of the disclosure, the radio access managing controller 140 receives an RRC reconfiguration message comprising a LR measurement from the network entity 200. The radio access managing controller 140 performs measurement on the LR band at the second radio 160 of the UE 100. The radio access managing controller 140 sends a measurement report to the network entity 200. The measurement report is sent over at least one of a signaling radio bearer 1 (SRB1) and an encapsulated SRB1 on the second radio 160. Based on the measurement report, the radio access managing controller 140 receives an RRC request from the network entity 200. The radio access managing controller 140 activates the second radio 160 based on the RRC request.

The radio access managing controller 140 transitions the second radio 160 into a low-power RRC idle state during at least one of: upon completion of the data transmission and triggering of a power saving condition.

In an embodiment of the disclosure, the radio access managing controller 140 monitors at least one of a paging signal, a low-power wake-up signal (LP-WUS), and a cell reselection signal while the second radio 160 is in the low-power RRC idle state. Further, the radio access managing controller 140 initiates a transition from the second radio 160 to the first radio 150 based on at least one event. The at least one event can be, for example, but not limited to: reception of the LP-WUS from the network entity 200, detection of the radio-link failure and the unsatisfied data requirement in the second radio 160.

In an embodiment of the disclosure, the radio access managing controller 140 receives an LP-WUS from the network entity 200 via at least one of: radio resource control (RRC) message, a medium access control control-element (MAC-CE), a downlink control information (DCI), or L1 information. Further, the radio access managing controller 140 performs uplink synchronization via RACH based on the LP-WUS. Further, the radio access managing controller 140 activates the first radio 150 upon the RACH success.

In another embodiment of the disclosure, the radio access managing controller 140 detects a failure in the LR operation. Further, the radio access managing controller 140 starts a recovery timer. Further, the radio access managing controller 140 switches the LR operation to the first radio 150 from the second radio 160 upon timer expiry or inability to recover service on the LR operation.

In another embodiment of the disclosure, the radio access managing controller 140 detects a LR exit event is triggered at the UE 100. The LR exit event can be, for example, but not limited to the temperature of the UE 100 greater than a predefined threshold, a battery level of the UE 100 less than a predefined threshold, a user of the UE 100 exiting a power save mode, and a heavy data activity. Based on the LR exit event, the radio access managing controller 140 switches the LR operation to the first radio 150 from the second radio 160.

Further, the radio access managing controller 140 performs a random access procedure (RACH) using one of: the first radio 150 and the second radio 160 based on a radio capability in response to the transition initiation. Further, the radio access managing controller 140 suspends an operation of the second radio 160 and activates the first radio 150 for continued communication of the UE 100 and the network entity 200 upon a successful RACH operation. Further, the radio access managing controller 140 deactivates the second radio 160 and initiates a service recovery procedure using the first radio 150 upon failure of the RACH operation.

Further, the processor 110 is configured to execute instructions stored in the memory 130 and to perform various processes. The communicator 120 is configured for communicating internally between internal hardware components and with external devices via one or more networks. The memory 130 also stores instructions to be executed by the processor 110. The memory 130 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 130 is non-movable. In certain examples, a non-transitory storage medium may store data that can, over time, change (e.g., in random access memory (RAM) or cache).

At least one of the plurality of modules may be implemented through the AI model. A function associated with AI may be performed through the non-volatile memory, the volatile memory, and the processor 110. The processor 110 may include one or a plurality of processors. At this time, one or a plurality of processors may be a general purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

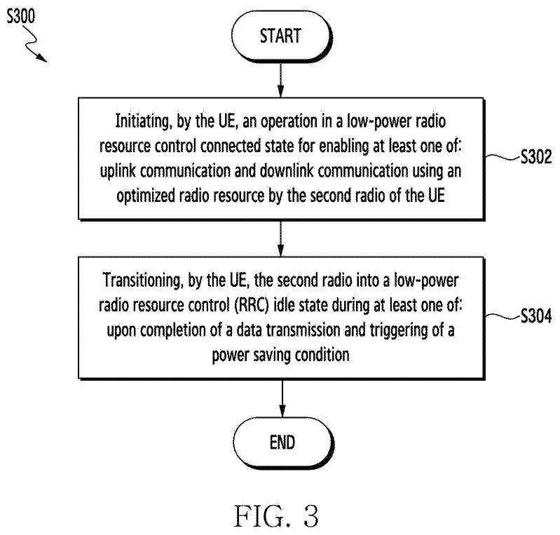

Although FIG. 3 shows various hardware components of the UE 100 but it is to be understood that other embodiments are not limited thereon. In other embodiments of the disclosure, the UE 100 may include less or more number of components. Further, the labels or names of the components are used only for illustrative purpose and does not limit the scope of the disclosure. One or more components can be combined together to perform same or substantially similar function in the UE 100.

FIG. 2 is a block diagram illustrating a network entity according to an embodiment of the disclosure.

Referring to FIG. 2, a network entity 200 may also include or be referred to by those skilled in the art as a base station, a base transceiver station, a radio base station, an access point, a radio transceiver, an eNB, a gNodeB (GNB), a 5G eNB, a transmission reception point (TRP), deployed on a radio access network (RAN), a virtualized radio access network (vRAN), Cloud RAN functionality or the like.

In an embodiment of the disclosure, the network entity 200 includes a processor 210, a communicator 220, memory 230, radio access managing controller 240, a first radio 250, and a second radio 260. The processor 210 is operated with the communicator 220, the memory 230, the radio access managing controller 240, the first radio 250, and the second radio 260. Further, the radio access managing controller 240 is physically implemented by analog or digital circuits, such as logic gates, integrated circuits, microprocessors, microcontrollers, memory circuits, passive electronic components, active electronic components, optical components, hardwired circuits, or the like, and may optionally be driven by firmware.

The radio access managing controller 240 monitors the power consumption of the network entity 200 by using a data driven model (e.g., machine learning model, artificial intelligence model or the like). Further, the radio access managing controller 240 transitions the second radio 260 from the first radio 250 based on the power consumption at the UE 100. The network entity 200 ensures the UE 100 from a plurality of UEs being served by the network entity 200 is switched to the second radio 260 from the first radio 250 to avoid a radio link loss. In an embodiment of the disclosure, the second radio 260 from the first radio 250 is switched by sending, by the network entity 200, an RRC Reconfiguration message comprising a LR measurement to the UE 100, where the UE 100 performs measurement on a LR band at the second radio 260 of the UE 100, receiving, by the network entity 200, the measurement report from the UE 100, and sending, by the network entity 200, an RRC request for activating the second radio 260 at the UE 100 based on the measurement report.

In summary, similar to the UE 100 in future network entity (e.g., gNB or the like) it is expected that even gNB will be operating in low power mode to reduce the carbon footprint. As a result there will be an entity in network end (e.g., gNB or core or both) which will be monitoring the power consumption of network side and trigger the transition from the MR to the LR based on the need to reduce the power consumption at the network side. Alternatively, the network entity 200 based on learning may utilize AI/ML model to switch between LR and MR to reduce the power consumption at the network entity 200. When the network entity 200 does the switch then it must ensure all the UEs 100 being served are also switched to the respective mode accordingly to avoid link loss.

Further, while switching between LR to MR or MR to LR, the network entity 200 may utilize the below listed parameters.
lowpowerRFConfig {
LP_PagingCycle ::=ENUMERATED {rf32, rf64, rf128, rf256: carries information about duration of the paging cycle in low power mode
LP_WUS_Periodicity (in msec or lp-pdcch count): carries information about periodicity of wake up signal which gNb will be transmitting
LP_WUS_Waveform (traditional time domain On-Off Keying (OOK), frequency domain OOK, or multi-tone signaling sequence): carries information about new signaling waveform which may be used for communication over low power radio
LP_ CarrierInfoLR (ARFCN, cellSelectionCritria): carries information about radio frequency information
Measurement perioditicy (in msec): carries information about periodicity measurement gap at which UE must ensure measurement of LR
cellSelectionCritria: can be minimum signal quality information for camping, SSB info detail: carries information about minimal signal quality needed for operating over LR

Further, the processor 210 is configured to execute instructions stored in the memory 230 and to perform various processes. The communicator 220 is configured for communicating internally between internal hardware components and with external devices via one or more networks. The memory 230 also stores instructions to be executed by the processor 210. The memory 230 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 230 may, in some examples, be considered a non-transitory storage medium. The term “non-transitory” may indicate that the storage medium is not embodied in a carrier wave or a propagated signal. However, the term “non-transitory” should not be interpreted that the memory 230 is non-movable. In certain examples, a non-transitory storage medium may store data that can, over time, change (e.g., in random access memory (RAM) or cache).

At least one of the plurality of modules may be implemented through the AI model. A function associated with AI may be performed through the non-volatile memory, the volatile memory, and the processor 210. The processor 210) may include one or a plurality of processors. At this time, one or a plurality of processors may be a general purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 2 shows various hardware components of the network entity 200 but it is to be understood that other embodiments are not limited thereon. In other embodiments of the disclosure, the network entity 200 may include less or more number of components. Further, the labels or names of the components are used only for illustrative purpose and does not limit the scope of the disclosure. One or more components can be combined together to perform same or substantially similar function in the network entity 200.

FIG. 3 is a flow chart S300 illustrating a method, implemented by a UE fo managing a radio access in the UE 100 having a first radio 150 and a second radio 160 according to an embodiment of the disclosure.

Referring to FIG. 3, the operations S302-S304 are handled by the radio access managing controller 140.

At operation S302, the method includes initiating the operation in the low-power radio resource control connected state for enabling at least one of: uplink communication and downlink communication using the optimized radio resource by the second radio 160 of the UE 100.

At operation S304, the method includes transitioning the second radio 160 into the low-power RRC idle state during at least one of: upon completion of the data transmission and triggering of the power saving condition.

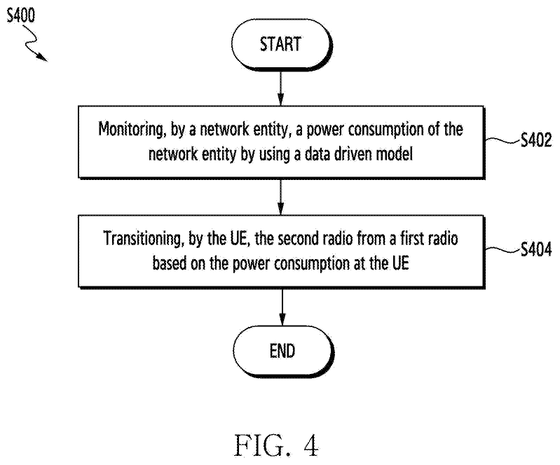

FIG. 4 is a flow chart S400 illustrating a method, implemented by a network entity for managing a radio access in a UE having a first radio and a second radio according to an embodiment of the disclosure.

Referring to FIG. 4, the operations S402-S404 are handled by the radio access managing controller 240.

At operation S402, the method includes monitoring the power consumption of the network entity 20) by using the data driven model. The data driven model can be, for example, but not limited to an AI model, ML model or the like.

At operation S404, the method includes transitioning the second radio 260 from the first radio 250 based on the power consumption at the UE 100.

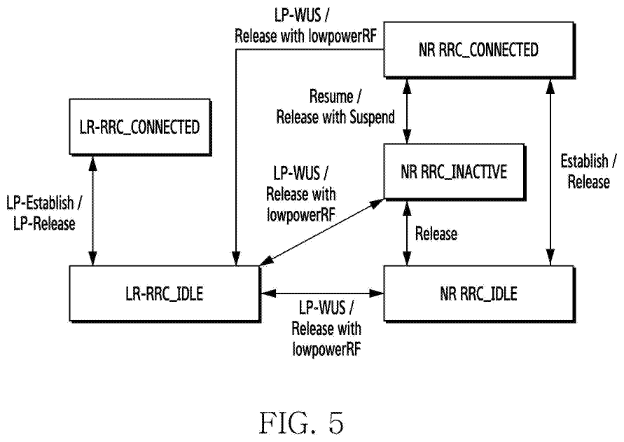

FIG. 5 depict an LR RRC state machine, and example events for state transitions from LR to MR respectively according to an embodiment of the disclosure.

Referring to FIG. 5, a LR-RRC connected is a lighter version of RRC connected where modem can operate with low power requirements. The LR-RRC idle is a lighter version of RRC idle where modem can operate with low power requirements. Here, the proposed method introduces a mechanism for RRC transition from low power radio to main radio and vice versa:
LP-Establish/LP-Release, and
LP-WUS/Release with lowpowerRF.
The LR functional protocol states are as follows:
LR-RRC_CONNECTED
transfer small data using LR (low power radio) uplink/downlink
LR-RRC_IDLE
LP-cell-reselection,
LP-cell-selection, and
LP-WUS monitoring.
Network initiated transition via any procedure
RRC,
MAC-CE,
DCI, and
L1 new waveform LP-WUS.
The UE 100 initiated transition via any procedure, such as:
Timer, and
RACH.

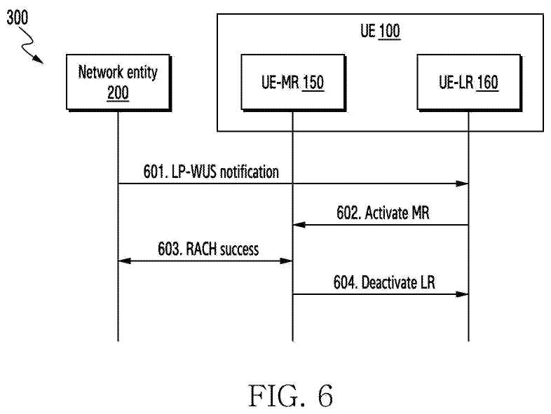

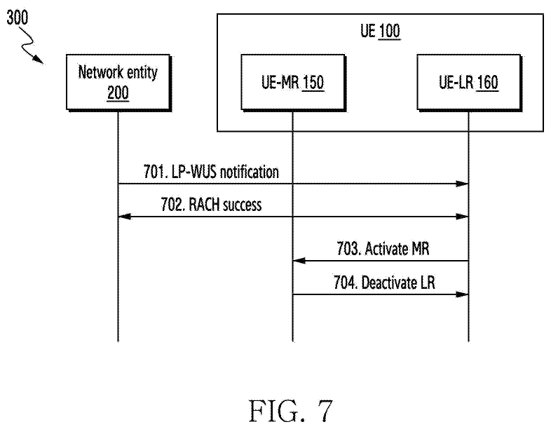

FIGS. 6 and 7 are sequence diagrams depicting a process of network entity directed LR to MR success scenarios according to various embodiments of the disclosure.

Referring to FIGS. 6 and 7, the network entity 200 sends a LP-WUS notification to the UE 100. The UE 100 makes uplink synchronisation with the network entity 200 by performing a successful RACH. The RACH could be sent over low power radio (LR) or high power radio (MR) based on RF capability. The UE 100 deactivates the low power (LP) radio. “The operations of the UE 100 makes uplink synchronisation with the network entity 200 by performing a successful RACH”, and “the RACH could be sent over low power radio (LR) or high power radio (MR) based on RF capability” can happen in synchronous or asynchronous manner.

Referring to FIG. 6, at operation 601, the network entity 200 sends the LP-WUS notification to the UE-LR 160. At operation 602, the UE-LR 160) activates the MR 150. At operation 603, the RACH success is between the network entity 200 and the UE MR 150. At operation 604, the UE MR 150 deactivates the LR 160.

Referring to FIG. 7, at operation 701, the network entity 200 sends the LP-WUS notification to the UE-LR 160. At operation 702, the RACH success is between the network entity 200 and the UE LR 160. At operation 703, the UE-LR 160 activates the MR 150. At operation 704, the UE MR 150 deactivates the LR 160.

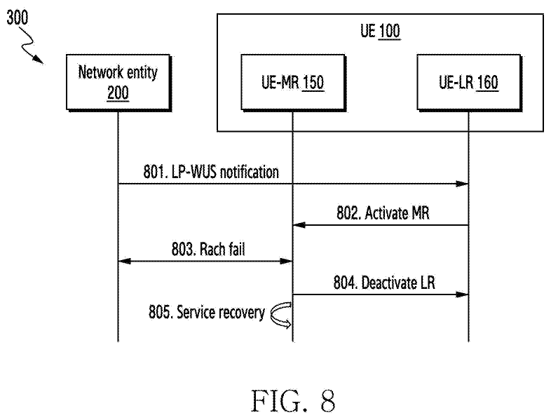

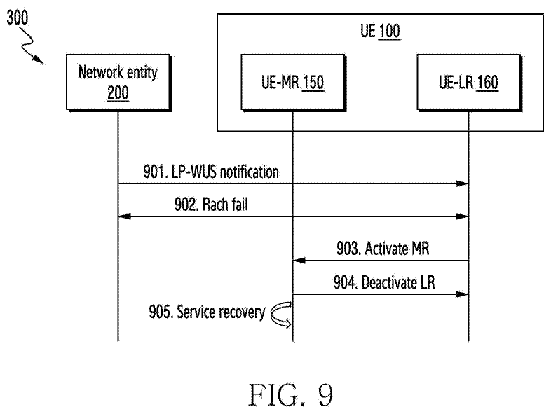

FIGS. 8 and 9 are sequence diagrams depicting a process of network entity directed LR to MR failure scenarios according to various embodiments of the disclosure.

Referring to FIG. 8, at operation 801, the network entity 200 sends the LP-WUS notification to the UE-LR 160. At operation 802, the UE-LR 160 activates the MR 150. At operation 803, the RACH fail is between the network entity 200 and the UE MR 150. At operation 804, the UE MR 150 deactivates the LR 160. At operation 805, the UE MR 150 performs a service recovery.

Referring to FIG. 9, at operation 901, the network entity 200 sends the LP-WUS notification to the UE-LR 160. At operation 902, the RACH fail is between the network entity 200 and the UE LR 160. At operation 903, the UE-LR 160 activates the MR 150. At operation 904, the UE MR 150 deactivates the LR 160. At operation 905, the UE MR 150 performs a service recovery.

In general, at operation 901, the network entity 200 sends the LP-WUS to the UE-LR 160. At operation 902, the UE 100 makes uplink synchronisation with the network entity 200 by performing RACH but the RACH ends up in a failure. At operation 903, the RACH could be sent over the low power radio (LR) or high power radio (MR) based on RF capability. At operation 904, the main radio (MR) deactivates low power radio and performs service recovery procedure at operation 905. The operations 902 and 903 can happen in synchronous or asynchronous manner.

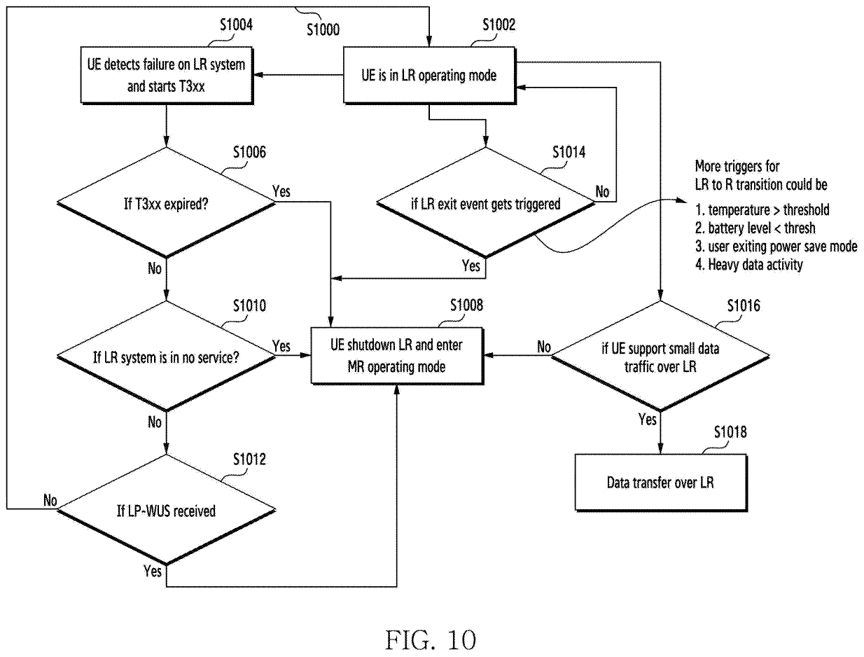

FIG. 10 illustrates a scenario in which LR to MR switch directed by a UE according to an embodiment of the disclosure.

Referring to FIG. 10, at operation S1002, the method determines that the UE 100 is in a LR operating mode.

At operation S1004, the method determines that the UE 100 detects failure on the LR mode and starts timer (e.g., T3xx or the like).

At operation S1006, the method determines whether the timer (e.g., T3xx) is expired. If it is determined that the timer (e.g., T3xx) is expired, then, at operation S1008, the UE 100 shutdowns the LR operating mode and enters the MR operating mode. If the timer (e.g., T3xx) is not expired, then, at operation S1010, the method includes determining whether the LR operating mode is in no service. If it is determined that the LR operating mode is in no service, then, at operation S1008, the UE 100 shutdowns the LR operating mode and enters the MR operating mode. If it is determined that the LR operating mode is not in no service, then, at operation S1012, the method includes determining whether the LP-WUS is received. If it is determined that the LP-WUS is received, then, at operation S1008, the UE 100 shutdowns the LR operating mode and enters the MR operating mode. If it is determined that the LP-WUS is not received, then, at operation S1002, the method includes detecting that the UE 100 is in the LR operating mode.

At operation S1014, the method includes determining whether the LR exit event gets triggered. If it is determined that the LR exit event gets triggered, then, at operation S1008, the UE 100 shutdowns the LR operating mode and enters the MR operating mode.

At operation S1016, the method includes determining whether the UE 100 supports small data traffic over the LR operating mode. If it is determined that the UE 100 supports small data traffic over the LR operating mode, then, at operation S1018, the UE 100 transfers the data over the LR operating mode. If it is determined that the UE 100 does not support the small data traffic over the LR operating mode, then, at operation S1008, the UE 100 shutdowns the LR operating mode and enters the MR operating mode.

In summary, consider, the UE 100 is in the LR operating mode and if the LR exit event gets triggered (by an event, such as, but not limited to, temperature >threshold, battery level <threshold, user exiting power save mode, heavy data activity, and so on) or the UE 100 does not support small data traffic over LR, the UE 100 shutdowns LR and enters the MR operating mode. If the UE 100 supports the small data traffic over LR, the UE 100 performs data transfer over the LR.

When the UE 100 is in LR operating mode, the UE 100 detects failure on LR system and starts the T3xx timer. If the T3xx timer has expired, the UE 100 shutdowns LR and enters the MR operating mode. If the T3xx timer has not expired, and if the LR system is not in ‘no service’, the UE 100 checks if the LP-WUS has been received. If the LR system is in ‘no service’, the UE 100 shutdowns LR and enters the MR operating mode. If LP-WUS has been received, the UE 100 shutdowns LR and enters the MR operating mode.

Embodiments herein disclose a LR idle to MR connected transition. Consider that the device is operating on LR, and the device receives LP-WUS or needs to send data which cannot be sent over LR. The UE 100
triggers cell selection on MR on cell information available in recent camped database or informed by the LR.
If successful acquisition then,
MR will trigger RACH
On successful RACH
suspend all operation on LR.
   Release all LR configuration
shutdown LR
else
Trigger full band scan on MR

Alternatively, if device is capable of sending the data traffic over LR then,
Device send data traffic over LR
Enters to LP RRC IDLE state post data traffic

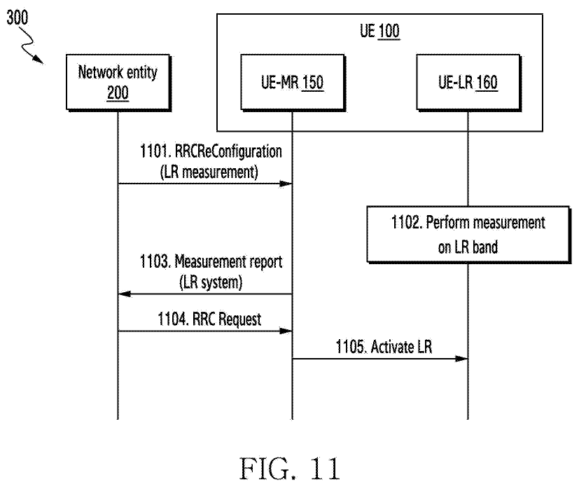

FIG. 11 is a sequence diagram illustrating a method to perform measurement in a UE (i.e., dual radio devices) according to an embodiment of the disclosure.

Referring to FIG. 11, in an embodiment of the disclosure, if MR and LR bands are different, then network may first configure L3/LTM/CHO measurement for the LR band. If LR uses different waveform than MR, then, in the proposed method, the network entity 200 may additionally introduce new measurement configuration of LR. This can be configured in dedicated RRCReconfig in MR. The proposed method adds new parameter in RRCReconfig for performing measurement of LR system. The measurement can be sent over SRB1/encapsulated SRB1 on MR.

If LR supports sending measurement report then configuration for MIB/SSB or reference signal on LR could be different than MR system. Hence it is needed that the UE 100 is aware of measurement configuration. The proposed method can be used to inform the UE 100 about these config. The proposed method can be used to add LRConfig in dedicated message in RRC (like measurement config) or via SIB1 over MR or RRCRelease. These LRConfig could be but not limited to below list:
ARFCN, carrying information about frequency on which LR should be measured,
waveform, carrying information about what waveform LR should be decoding signal, and
periodicity, carrying information about at what periodicity should LR attempt to perform measurement.

Such LR measurement information can be shared for multiple ARFCN as a list.

Referring to FIG. 11, at operation 1101, the network entity 200 sends a RRCReConfiguration (including the LR measurement) to the UE-MR 150. At operation 1102, the UE-LR 160 performs the measurement on the LR band. At operation 1103, the UE-MR 150 sends the measurement report (including the LR system) to the network entity 200. At operation 1104, the network entity 200 sends a RRC request to the UE-MR 150. At operation 1105, the UE-MR 150 activates the UE-LR 160.

The various actions, acts, blocks, steps, or the like in the flow charts (S300, S400, and S1000) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the network elements. The elements include blocks which can be at least one of a hardware device, or a combination of hardware device and software module.

While the disclosure has been shown and described with reference to various embodiments thereof, it will be understood by those skilled in the art that the various changes in form and details may be made therein without departing from the spirit and scope of the disclosure as defined by the appended claims and their equivalents.

What is claimed is:

1. A method performed by a user equipment (UE) having a first radio and a second radio for managing a radio access, the method comprising:
initiating an operation in a low-power radio resource control connected state for enabling at least one of uplink communication or downlink communication using an optimized radio resource by the second radio of the UE; and
transitioning the second radio into a low-power radio resource control (RRC) idle state during at least one of upon completion of a data transmission or triggering of a power saving condition.

2. The method of claim 1, wherein the first radio includes a main radio (MR) and the second radio includes a low power radio (LR).

3. The method of claim 2, further comprising:
monitoring at least one of a paging signal, a low-power wake-up signal (LP-WUS), or a cell reselection signal while the second radio is in the low-power RRC idle state;
initiating a transition from the second radio to the first radio based on at least one event; and
performing a random access procedure (RACH) using one of the first radio or the second radio based on a radio capability in response to the transition initiation.

4. The method of claim 3, wherein the initiating, by the UE, of the transition from the second radio to the first radio comprises:
receiving an LP-WUS from a network entity via at least one of radio resource control (RRC) message, a medium access control control-element. (MAC-CE), a downlink control information (DCI), or L1 information;
performing uplink synchronization via RACH based on the LP-WUS; and
activating the first radio upon success of the RACH.

5. The method of claim 3, wherein the initiating, by the UE, of the transition from the second radio to the first radio comprises:
detecting a failure in the LR operation;
starting a recovery timer; and
switching the LR operation to the first radio from the second radio upon timer expiry or inability to recover service on the LR operation.

6. The method of claim 3, wherein the initiating, by the UE, of the transition from the second radio to the first radio comprises:
detecting a LR exit event is triggered at the UE; and
switching the LR operation to the first radio from the second radio based on the LR exit event.

7. The method of claim 6, wherein the LR exit event comprises at least one of:
a temperature of the UE greater than a predefined threshold;
a battery level of the UE less than a predefined threshold;
a user of the UE exiting a power save mode; or
a heavy data activity.

8. The method of claim 3, wherein the at least one event comprises at least one of:
reception of the LP-WUS from a network entity; or
detection of a radio-link failure and an unsatisfied data requirement in the second radio.

9. The method of claim 3, wherein the performing of the RACH further comprises performing, by the UE, one of:
suspending an operation of the second radio and activating the first radio for continued communication of the UE and a network entity upon a successful RACH operation; or
deactivating the second radio and initiating a service recovery procedure using the first radio upon failure of the RACH operation.

10. The method of claim 1, wherein the UE initiates the data transmission in the low-power radio resource control connected state without activating the first radio.

11. The method of claim 1, wherein the initiating, by the UE, of the operation in the low-power radio resource control connected state for enabling at least one of the uplink communication or the downlink communication using the optimized radio resource by the second radio of the UE comprises:
receiving an RRC Reconfiguration message comprising a LR measurement from a network entity;
performing measurement on a LR band at the second radio of the UE;
sending a measurement report to the network entity;
receiving an RRC request from the network entity based on the measurement report; and
activating the second radio based on the RRC request.

12. The method of claim 11, wherein the measurement report is sent over at least one of a signaling radio bearer 1 (SRB1) or an encapsulated SRB1 on the second radio.

13. A user equipment (UE) including a first radio and a second radio, the UE comprising:
memory, comprising one or more storage media, storing instructions;
a radio access managing controller; and
at least one processor communicatively coupled to the memory and the radio access managing controller,
wherein the instructions, when executed by the at least one processor individually or collectively, cause the UE to:
initiate an operation in a low-power radio resource control connected state for enabling at least one of uplink communication or downlink communication using an optimized radio resource by the second radio of the UE, and
transition the second radio into a low-power radio resource control (RRC) idle state during at least one of upon completion of a data transmission or triggering of a power saving condition.

14. The UE of claim 13, wherein the first radio includes a main radio (MR) and the second radio includes a low power radio (LR).

15. The UE of claim 14, wherein the instructions, when executed by the at least one processor individually or collectively, further cause the UE to:
monitor at least one of a paging signal, a low-power wake-up signal (LP-WUS), or a cell reselection signal while the second radio is in low-power RRC idle state,
initiate a transition from the second radio to the first radio based on at least one event, and
perform a random access procedure (RACH) using one of the first radio or the second radio based on a radio capability in response to transition initiation.

16. The UE of claim 15, wherein the instructions, when executed by the at least one processor individually or collectively, further cause the UE to:
receive an LP-WUS from a network entity via at least one of a radio resource control (RRC) message, a medium access control control-element. (MAC-CE), a downlink control information (DCI), or L1 information,
perform uplink synchronization via RACH based on the LP-WUS, and
activate the first radio upon success of the RACH.

17. The UE of claim 15, wherein the instructions, when executed by the at least one processor individually or collectively, cause the UE to:
detect a failure in the LR operation;
start a recovery timer; and
switch the LR operation to the first radio from the second radio upon timer expiry or inability to recover service on the LR operation.

18. The UE of claim 15, wherein the instructions, when executed by the at least one processor individually or collectively, cause the UE to:
detect a LR exit event is triggered at the UE; and
switch the LR operation to the first radio from the second radio based on the LR exit event.

19. The UE of claim 18, wherein the LR exit event comprises at least one of:
a temperature of the UE greater than a predefined threshold;
a battery level of the UE less than a predefined threshold;
a user of the UE exiting a power save mode; or
a heavy data activity.

20. The UE of claim 15, wherein the at least one event comprises at least one of:
reception of the LP-WUS from a network entity; or
detection of a radio-link failure and an unsatisfied data requirement in the second radio.
